(19) United States
(12) Patent Application Publication
(10) Pub. No.: US 2002/0033363 A1
(43) Pub. Date: Mar. 21, 2002

(54) Containerized polluted-water treatment apparatus

(75) Inventor: Moriju Hasegawa, Tokyo (JP)

Correspondence Address: MILLEN, WHITE, ZELANO & BRANIGAN, P.C., 2200 CLARENDON BLVD., SUITE 1400, ARLINGTON, VA, 22201, US

(73) Assignee: RESOUSE BIOLOGY RESEARCH INSTITUTE CO., LTD., Tokyo (JP)

(21) Appl. No.: 09/903,672

(22) Filed: Jul. 13, 2001

(30) Foreign Application Priority Data
Sep. 19, 2000 (JP) 2000-254673A

(51) Int. Cl. C02F 3/10

(52) U.S. Cl. 210/151; 210/202; 210/241

(57) ABSTRACT

A containerized polluted-water treatment apparatus which is mobile and transportable and easily installed in the neighborhood of a polluted water source without any particular works, characterized by comprising at least one container that has a water inlet and a water outlet and is provided with a water treatment unit having biological supports and a combination of a power unit and a control device by which the water treatment unit is operated.

### FIELD OF THE INVENTION

The present invention relates to a mobile and transportable apparatus for water treatment and, more particularly, to a containerized polluted-water treatment apparatus which can be easily installed in the neighborhood of a polluted water source without any particular works, and besides, can be removed and replaced.

### BACKGROUND OF THE INVENTION

An activated sludge method is representative of hitherto known methods for polluted water treatment. According to this method, polluted water can be treated in large quantity so far as the BOD thereof is about 300 mg/l or below. Therefore, such a method is utilized mainly by large-scale facilities such as filtrate plants.

However, polluted water to be treated is widely diverse in its origin. Specifically, the origins thereof include rivers, meres and lakes, oceans, domestic wastewater and industrial wastewater. Therefore, it is necessary to devise methods considered most suitable for the treatment targets respectively and address specific needs of individual targets.

Under these circumstances, the polluted water treatment method utilizing microorganisms attached to biological supports has come to find its application in various areas, because it has advantages that it enables apparatus size reduction, highly efficient BOD-abatement, denitrification with anaerobic bacteria, and elimination of fats and oils in which the activated sludge methods have failed. Such being the case, demands for small-scale apparatus and testing apparatus are now increasing, but no polluted-water treatment apparatus of mobile and transportable type has been known yet.

### SUMMARY OF THE INVENTION

A first object of the invention is therefore to provide a mobile and transportable containerized polluted-water treatment apparatus that can be easily installed without any particular works.

A second object of the invention is to provide a containerized polluted-water treatment apparatus that is compact, mobile and transportable, and well suitable for testing use which is made depending on the type of polluted water.

A third object of the invention is to provide a containerized polluted-water treatment apparatus which is suitable for treatment of waste water from restaurants, perishables markets and the like, and usable easily on the spot even in urban areas.

The aforementioned objects are attained with a containerized polluted-water treatment apparatus comprising at least one container that has a water inlet and a water outlet and is provided with a water treatment unit having biological supports and a combination of a power unit and a control device by which the water treatment unit is operated.

### BRIEF DESCRIPTION OF THE DRAWINGS

FIG. 1 is a schematic side view of a containerized polluted-water treatment apparatus loaded on a truck according to the invention.

FIG. 2 is a schematic plan view of a containerized polluted-water treatment apparatus loaded on a truck according to the invention.

FIG. 3 is a schematic diagram showing an example of a treatment process applicable to the present containerized polluted-water treatment apparatus.

The reference numerals and characters in the figures stand for the following:

1 Containerized polluted-water treatment apparatus

2 Pretreatment tank

3 Biological reactor

3′ Pump chamber

4 Biomodule-type aeration tank

5 Sedimentation-separation tank

6 Electric generator

7 Control panel

8 Auxiliary fuel

A, B Blower

### DETAILED DESCRIPTION OF THE INVENTION

To the present polluted-water treatment apparatus, treatment tanks provided with biological supports are essential in achieving an apparatus size reduction and highly efficient treatment.

A container used in the invention has a pair of water inlet and outlet. When the present treatment apparatus is constructed of two containers, the water outlet of one container is connected to the water inlet of the other container.

Of course, the treatment apparatus may be housed in its entirety in one container, or can be designed so as to connect three or more containerized units with one another. For sucking up polluted water from a polluted water source, a water suction means is designed appropriately and connected to the raw water inlet of a container. It is appropriate that such a means be accordion in shape and easily transformable.

For the size of a container, the optimum value is chosen depending on the water treatment capacity required. In view of road conditions in Japan, it is appropriate that the container measure 2.2 m or below in width, 6 m or below in length and 2.2 m or below in height, and be loadable on a 4-ton truck.

However, it is not necessary to limit the container size to the above-described range. For instance, in the case of equipping small-scale restaurants and the like, boxes of appropriate sizes can be designed. Therefore, the concept of containers in the invention should not be construed as being limited to available containers of standardized sizes.

The present containerized polluted-water treatment apparatus is provided with a power unit for operating a suction pump by which polluted water is sucked up, a metering pump by which the water to be treated is made to flow in a controlled quantity and blowers by which the polluted-water treatment tanks are aerated, and additionally a microfilter device and a reverse osmosis device, if needed. This power unit is generally an electric powder unit that can function when electricity is supplied thereto. In order to secure mobility in particular, it is desirable for the present apparatus to be equipped with an electric generator for the foregoing power supply.

The structure of the present polluted-water treatment apparatus provided with biological supports and the sizes of treatment tanks can be determined appropriately depending on the type and degree of pollution of water to be treated, and the target figures of check items required for the treated water. In the simplest case, for instance, the apparatus comprises only one treatment tank wherein an aeration device is installed and biological supports are placed. As circumstances demand, the foregoing apparatus may further comprise a biological supports-equipped pretreatment tank positioned in front of the treatment tank and a sedimentation tank positioned at the rear of the treatment tank. When polluted water has a high BOD value, a reaction tank (a biological reactor) wherein biological supports are positioned so as to dangle from a frame and float in the air and thereon the polluted water to be treated is sprayed can further be placed in front of the sedimentation tank or between the aforesaid pretreatment tank and the treatment tank provided with an aeration device and biological supports.

Furthermore, a microfilter device can be positioned so as to treat the water after passing through the sedimentation tank, and thereby it becomes possible to use the treated water as tap water. In the case of seawater treatment, a reverse osmosis device is positioned so as to treat the water after passing through a microfilter device, and enables conversion from polluted seawater into pure freshwater. Either the microfilter device or the reverse osmosis device, or both of these devices may be incorporated into the present containerized apparatus, or may be housed in a separate case designed to be attached to the present apparatus when required.

The control device is provided in order for the polluted-water treatment apparatus comprised of the aforementioned devices and tanks to be operated under prescribed conditions, and thereto a warning device may be attached, if desired.

A containerized polluted-water treatment apparatus according to the invention is conveyable, and besides, it is in advance equipped with all the devices necessary for polluted-water treatment. Therefore, the present apparatus can be used at once on the spot where it is brought in, and requires no special installation works. Further, the present apparatus is ready for downsizing on an as needed basis, so that it can speedily answer needs in urban areas with reliability. Furthermore, the present apparatus can be much increased in mobility by installation of an electric generator, and so it can come into play in securing the supply of low-grade and high-grade tap water.

The present invention will now be described with reference to specific examples, but it should be understood that these examples are not to be construed as limiting the scope of the invention in any way.

### EXAMPLES

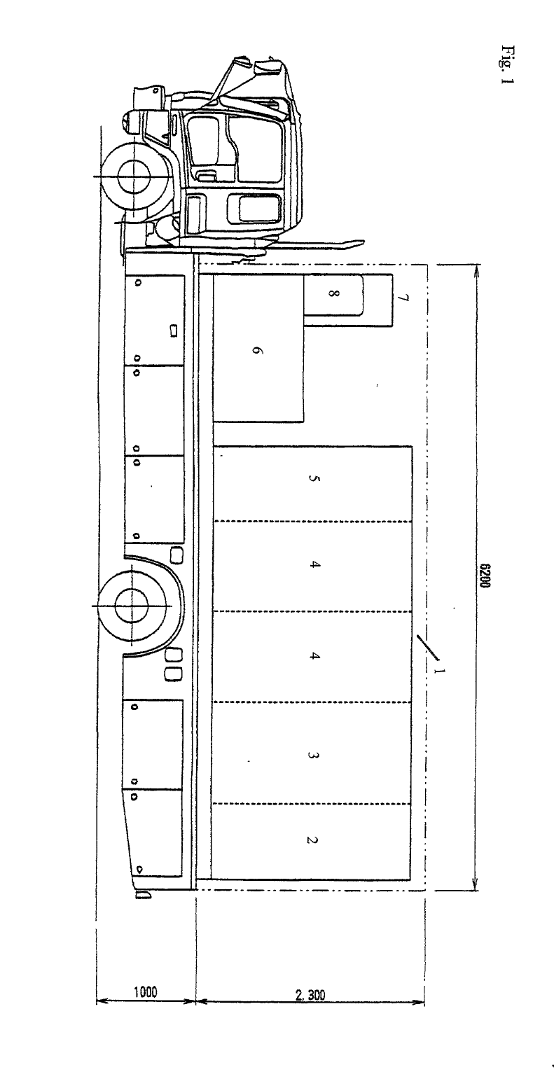

FIG. 1 shows a schematic side view of a containerized polluted-water treatment apparatus (1) according to the invention in a state that the apparatus is loaded on a truck. In the embodiment of FIG. 1, the biological supports-installed water treatment part of the apparatus comprises a pretreatment tank (2), a biological reactor (3), aeration tanks having biological supports (which are each referred to as “a biomodule-type aeration tank (4)”), and a sedimentation tank (5). Additionally, the sedimentation tank has in general no biological supports.

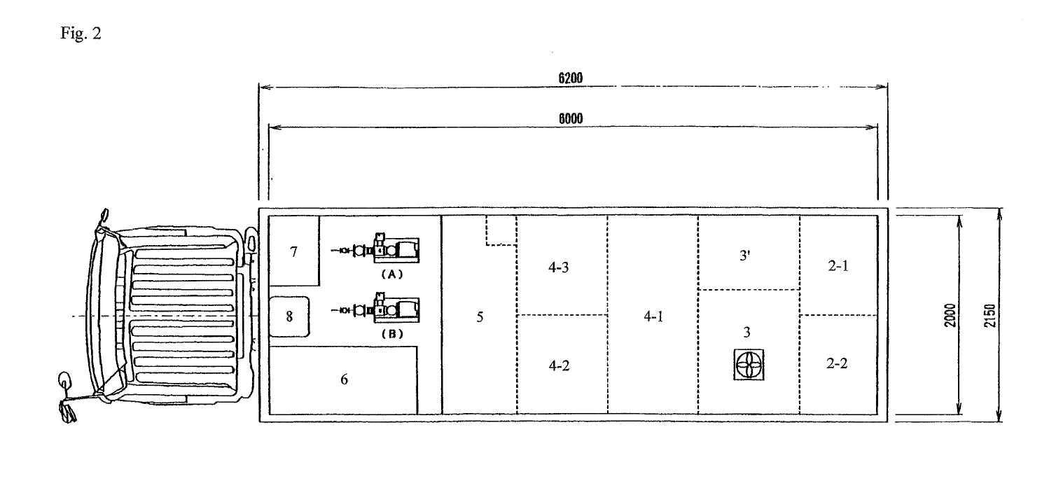

FIG. 2 is a schematic plan view of the containerized polluted-water treatment apparatus shown in FIG. 1. As shown in FIG. 2, the apparatus according to this embodiment is equipped with blowers (A) and (B) which are arranged parallel to an electric generator (6). Further, the pretreatment tank (2) is two-segmented, and the treatment tank (4) provided with an aeration device and biological supports is three-segmented. In addition, a pump for spraying water into the biological reactor is housed in a pump chamber (3′) arranged side by side with the biological reactor. In this pump chamber, other pumps including a feedwater pump and a metering pump are also housed.

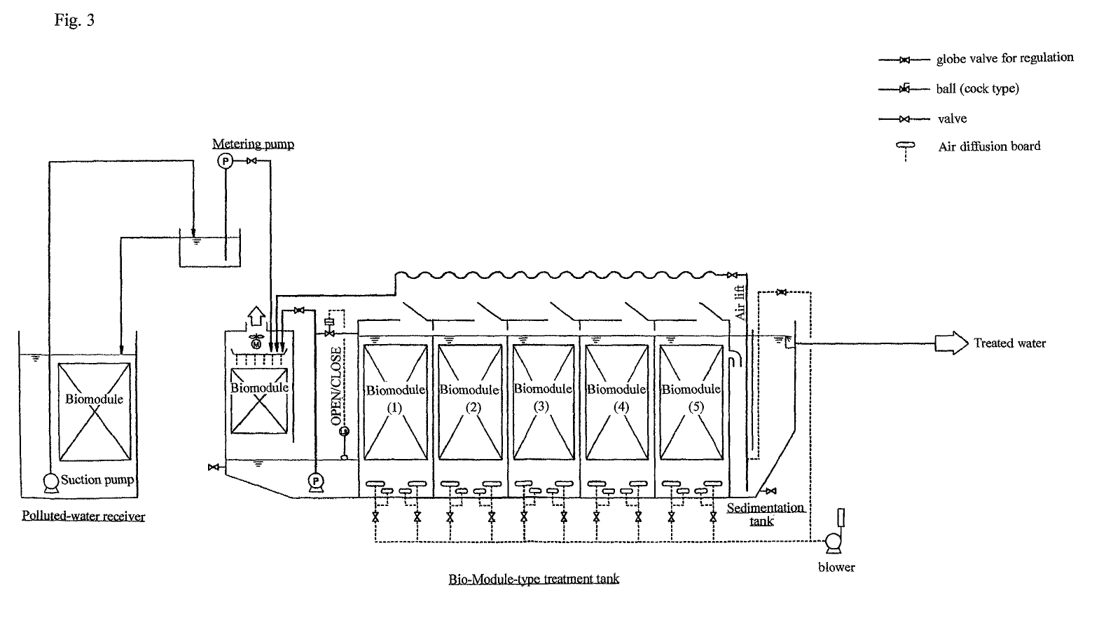

When polluted water does not continuously flow into the treatment apparatus as in the case of liquid wastes, a polluted-water receiver becomes necessary. In general, this receiver is installed separately from the present apparatus, and the polluted water stored in the receiver is pumped up and subjected to the treatment using the present apparatus. On the other hand, it is also naturally enough to incorporate the polluted-water receiver into the present apparatus. FIG. 3 is a schematic diagram showing an example of a treatment process applied to the case where the present containerized polluted-water treatment apparatus is equipped with a polluted-water receiver.

What is claimed is:

1. A containerized polluted-water treatment apparatus comprising at least one container that has a water inlet and a water outlet and is provided with a water treatment unit having biological supports and a combination of a power unit and a control device by which the water treatment unit is operated.

2. A containerized polluted-water treatment apparatus according to claim 1, wherein the power unit is equipped with an electric generator.

3. A containerized polluted-water treatment apparatus according to claim 1 or 2, wherein the water treatment unit comprises at least a water treatment tank provided with a suction pump, an aeration device and biological supports, and a sedimentation tank.

4. A containerized polluted-water treatment apparatus according to claim 3, wherein the water treatment unit further has in front of the water treatment tank a pretreatment tank provided with biological supports.

5. A containerized polluted-water treatment apparatus according to claim 3, wherein the water treatment unit further has a microfilter device positioned so as to treat the water after passing through the sedimentation tank.

6. A containerized polluted-water treatment apparatus according to claim 5, wherein the water treatment unit further has a reverse osmosis device positioned so as to treat the water after passing through the microfilter device.

7. A containerized polluted-water treatment apparatus according to claim 5, wherein the microfilter device is housed in a separate case designed to be attached to the treatment apparatus when required.

8. A containerized polluted-water treatment apparatus according to claim 6, wherein the microfilter device and the reverse osmosis device are housed in a separate case designed to be attached to the treatment apparatus when required.

9. A containerized polluted-water treatment apparatus according to any of claims 3 to 8, wherein a metering pump is further positioned so that polluted water sucked up by the suction pump is made to flow in a controlled quantity.
